(19) United States
(12) Patent Application Publication
(10) Pub. No.: US 2026/0325256 A1
(43) Pub. Date: Oct. 22, 2026

(54) DENTAL IMPLANT GUIDE SYSTEM AND METHOD

(71) Applicant: New York University, New York, NY (US)

(72) Inventors: Young Kwang KIM, Brooklyn, NY (US); Maikel GHALY, East Brunswick, NJ (US)

(21) Appl. No.: 19/652,210

(22) Filed: Apr. 20, 2026

Related U.S. Application Data
(60) Provisional application No. 63/791,986, filed on Apr. 21, 2025.

(51) Int. Cl. A61C 1/08; A61C 8/00

(52) U.S. Cl. CPC A61C 1/084; A61C 8/0089

(57) ABSTRACT

A device is for guided pilot osteotomy in preparation for a dental implant. The device includes a guide sleeve extending longitudinally from a first end to a second and including a channel extending therethrough along a central axis; and a first clamp arm and a second clamp arm extending from opposing sides of the guide sleeve. The first and second clamp arms are configured to be positioned along buccal and lingual surfaces of an alveolar ridge to position the guide sleeve in the target edentulous area so that the central axis of the channel extends along a desired path of insertion of an implant.

### PRIORITY CLAIM

The present application claims priority to U.S. Provisional Patent Application Serial No, 63/791,986 filed on Apr. 21, 2025, the entire disclosure of which is incorporated herein by reference.

### FIELD

The present disclosure relates to dental implants and, in particular, relates to systems and methods for guided pilot drilling in preparation for implant placement

### BACKGROUND

Dental implants may be used to treat tooth loss by replacing a tooth root with an implant post so that a dental crown (e.g., prosthetic tooth) may be attached thereto. Dental implant surgery involves drilling a socket into the alveolar, inserting the implant post therein and, upon osseointegration of the implant post, attaching the crown to the post via, for example, an abutment. As will be understood by those of skill in the art, a positioning of the implant post (e.g., angulation and/or orientation) within the bone is critical for successful implantation.

While many technological advancements have been made in the surgical arena of computer-guided implant placement (e.g., static, dynamic, robotic and augmented reality), in resource-constrained environments these computer-guided methods may be impractical. For example, in contrast to private practices, academic research institutions may have limited access to radiographic imaging. Factors such as location of radiographic scanning machines and/or detachment of the robotic tracker may affect the practicality of computer-guided methods. Thus, despite technological advancements, freehand techniques may still be preferred in some cases.

### SUMMARY

The present disclosure relates to a device for guided pilot osteotomy in preparation for a dental implant. The device includes a guide sleeve extending longitudinally from a first end to a second and including a channel extending therethrough along a central axis; and a first clamp arm and a second clamp arm extending from opposing sides of the guide sleeve, the first and second clamp arms configured to be positioned along buccal and lingual surfaces of an alveolar ridge to position the guide sleeve in the target edentulous area so that the central axis of the channel extends along a desired path of insertion of an implant.

In an embodiment, the device further includes a first flange extending from the guide sleeve, between the first clamp arm and the second clamp arm so that when the first and second clamp arms extend over buccal and lingual surfaces, respectively, in an operative position, the first flange is configured to engage a first adjacent structure positioned mesially of the target edentulous area.

In an embodiment, the device further includes a second flange extending from the guide sleeve so that the second flange diametrically opposes the first flange, the second flange configured to engage a second adjacent structure positioned distally of the target edentulous area so that the guide sleeve is in mesiodistal alignment with the first and second adjacent structures.

In an embodiment, the first and second flanges are sized and shaped to engage an undercut of adjacent dentitions’ interproximal region mesial and distal positions.

In an embodiment, each of the first and second clamp arms include a protrusion extending therefrom toward the central axis C to engage the buccal and lingual surfaces, in the operative position, the protrusions stabilize the guide sleeve in the target edentulous area and anchors the guide sleeve relative to an apical aspect of an osteotomy so that the central axis is centered with respect to the apical aspect.

In an embodiment, each of the first and second clamp arms are connected to the guide sleeve via a connector extending laterally from the guide sleeve from opposing sides thereof, each of the first and second clamp arms extend from a first end connected to connector to a second end.

In an embodiment, each of the first and second clamp arms taper from the first end toward the second end.

In an embodiment, the first and second clamp arms are equidistant from the guide central axis of the channel of the guide sleeve.

In an embodiment, a distance between the first and second clamp arms corresponds to a width of the alveolar ridge along the target edentulous area.

In an embodiment, a distance between the first and second flanges corresponds to a size of the target edentulous area.

In an embodiment, the device further includes a metal insert sized shaped and configured to be received within the channel of the guide sleeve so that a channel of the metal insert extends coaxially therewith.

In an embodiment, a portion of the metal insert is sized, shaped and configured to engage a portion of an implant drill to define a maximum extent of insertion of the implant drill therethrough.

In addition, the present disclosure relates to a device for guided pilot osteotomy in preparation for a dental implant. The device include a guide sleeve extending longitudinally from a first end to a second and including a channel extending therethrough along a central axis; and a first clamp arm and a second clamp arm extending from opposing sides of the guide sleeve, the first and second clamp arms configured to be positioned along buccal and lingual surfaces of an alveolar ridge to position the guide sleeve in the target edentulous area so that the central axis of the channel extends along a desired path of insertion of an implant that is anchored with respect to an apical aspect of an osteotomy; and a first flange and a second flange extending from opposing sides of the guide sleeve, the first and second flanges being sized, shaped and configured to engage adjacent structures on either side of the target edentulous area to provide a mesiodistal alignment of the central axis of the guide sleeve.

In an embodiment, the device further includes a metal insert sized shaped and configured to be received within the channel of the guide sleeve so that a channel of the metal insert extends coaxially therewith.

In an embodiment, the metal insert is sized, shaped and configured to engage a portion of an implant drill.

In an embodiment, each of the first and second clamp arms includes a protrusion extending therefrom, toward the central axis of the channel, to the buccal and lingual surfaces over which the first and second arms extend.

In an embodiment, each of the first and second clamp arms taper from a first end connected to the guide sleeve toward a second free end.

In an embodiment, each of the first and second flanges extend from a first end connected to the guide sleeve to a second free end that is sized, shaped and configured to engage an undercut of a tooth.

In addition, the present disclosure relates to a method for accurate pilot drilling in preparation for a dental implant, comprising: positioning a guide device over an alveolar ridge of a target edentulous area such that a first clamp arm of the guide device extends over a buccal surface of the alveolar ridge and a second clamp arm of the guide device extends over a lingual surface of the alveolar ridge so that a guide sleeve is anchored with respect to an apical aspect of an osteotomy and a central axis of a channel of the guide sleeve extends along a target path of insertion of an implant.

In an embodiment, the positioning the guide device further includes engaging a flange of the guide device with an adjacent structure of the target edentulous area so that the central axis of the channel of the guide sleeve is in mesiodistal alignment with the adjacent structure.

### BRIEF DESCRIPTION

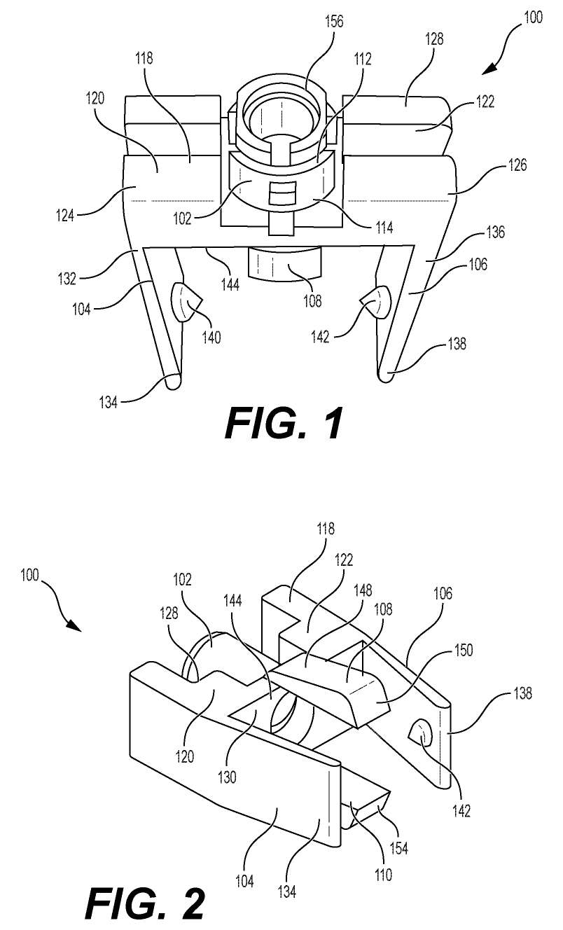

FIG. 1 shows a perspective view of a guide device according to an exemplary embodiment of the present disclosure;

FIG. 2 shows another perspective view of the guide device according to the exemplary embodiment of FIG. 1;

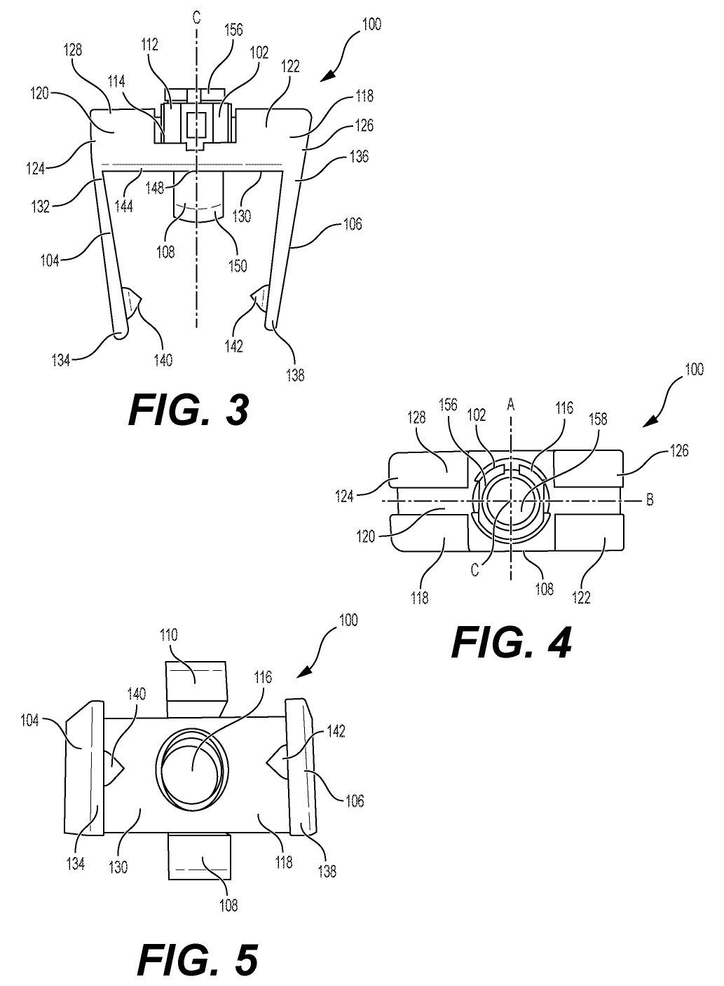

FIG. 3 shows a side view of the guide device according to the exemplary embodiment of FIG. 1;

FIG. 4 shows a plan view of the guide device according to the exemplary embodiment of FIG. 1;

FIG. 5 shows another plan view of the guide device according to the exemplary embodiment of FIG. 1;

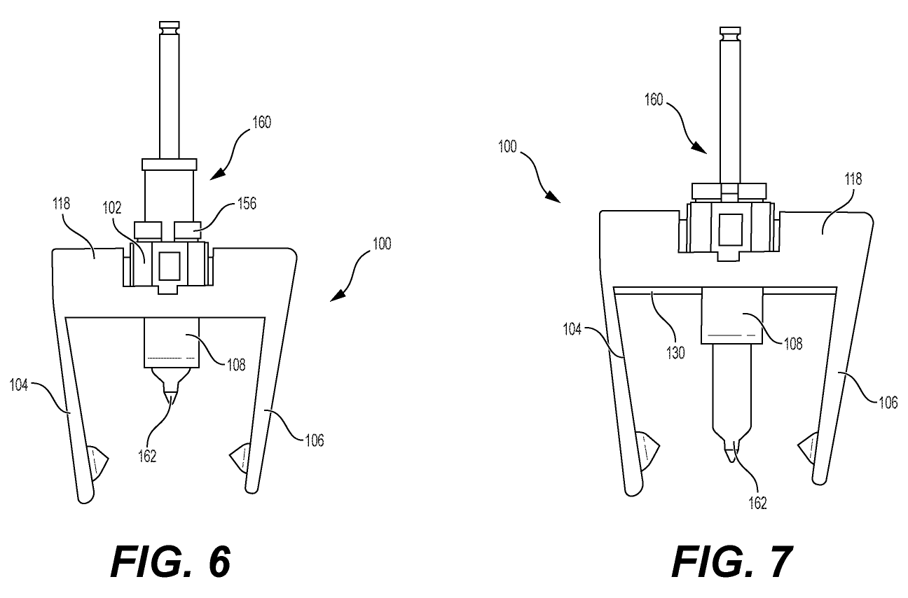

FIG. 6 shows a side view of the guide device and an implant drill inserted through a guide sleeve thereof according to the exemplary embodiment of FIG. 1;

FIG. 7 shows a side view of the guide device and the implant drill inserted through a guide sleeve thereof according to FIG. 6, the implant drill inserted to a maximum extent;

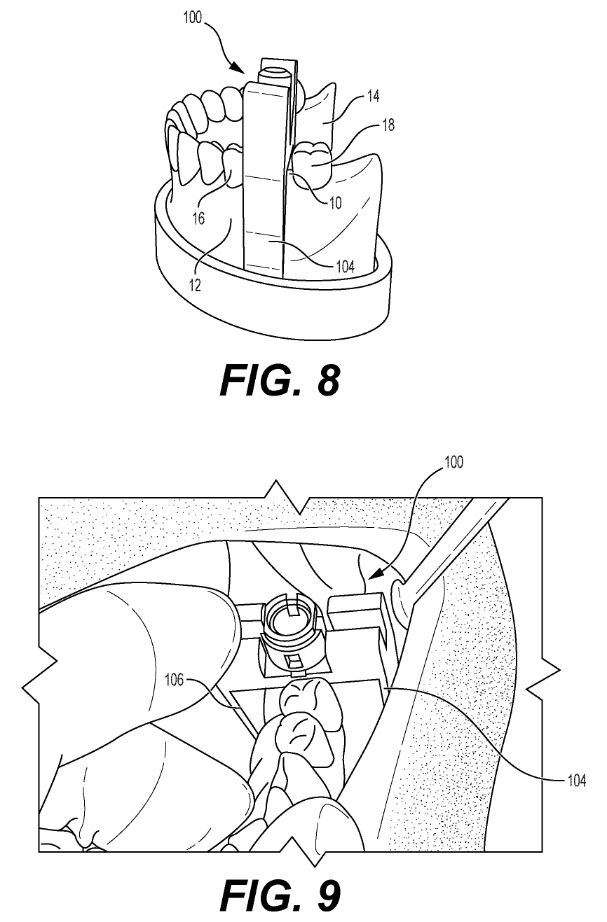

FIG. 8 shows an example of the guide device according to FIG. 1 positioned over a target edentulous area;

FIG. 9 shows another example of the guide sleeve according to FIG. 1 positioned over a target edentulous area; and

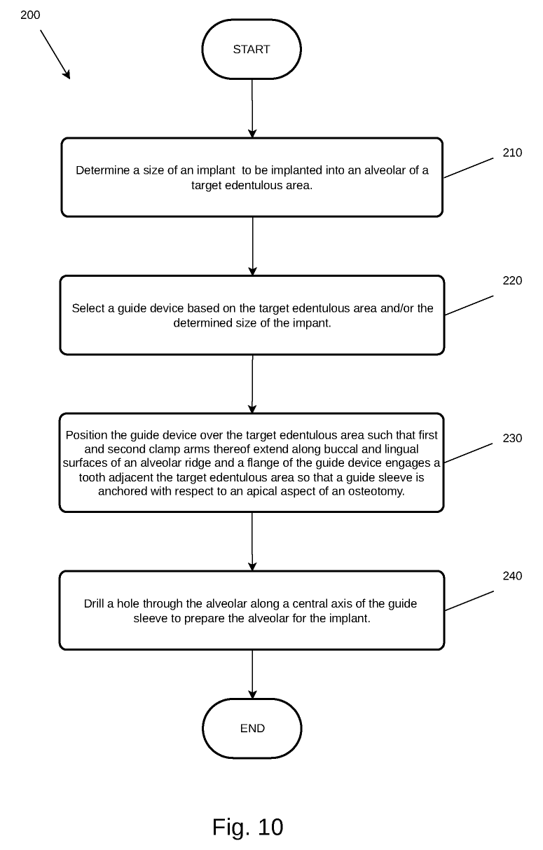

FIG. 10 shows a flow diagram of a method according to an exemplary embodiment of the present disclosure.

### DETAILED DESCRIPTION

The present disclosure relates to dental implant placements and, in particular, relates to systems and method for accurate implant placement using analog techniques – e.g., without the need for cone beam computed tomography (CBCT) imaging. Exemplary embodiments show and describe a device configured to provide a guide for accurate pilot drilling in preparation for implant placement, without requiring radiographic image verification. According to an exemplary embodiment, the device comprises a guide sleeve configured to be positioned over an alveolar ride, in a target edentulous area, so that the guide sleeve is anchored with respect to an apical aspect of an osteotomy - e.g., a depth of a socket that is to be surgically created – so that a central axis of the guide sleeve is substantially aligned with an optimal orientation (e.g., angulation) of the implant within the bone. It should be noted that the terms used herein (e.g., buccal, lingual, medial, distal, etc.) are intended to refer to positional and directional terms for dental anatomy.

As shown in FIGS. 1-7, a guide device 100 according to an exemplary embodiment of the present disclosure comprises a guide sleeve 102 fixed between a first clamp arm 104 and a second clamp arm 106 which are configured to be positioned along buccal and lingual surfaces of an alveolar ridge in a clamp-like fashion so that the guide sleeve 102 is positioned in a target edentulous area and a central axis C along which the guide sleeve 102 extends is aligned with a target path of insertion of an implant into a bone (e.g., alveolar bone). The device 100 may further comprise a first flange 108 and a second flange 110 configured to engage structures (e.g., teeth) adjacent to the edentulous area so that the guide sleeve 102 is also positioned in mesiodistal alignment with the adjacent structures. As will be understood by those of skill in the art, the path along which the central axis C extends corresponds to an axis along which the socket is to be drilled.

According to an exemplary embodiment, when the first and second clamp arms 104, 106 are clamped along the buccal and lingual surfaces, respectively, and/or the first and second flanges 108, 110 engage the adjacent structures of the target edentulous area, the guide sleeve 102 is positioned in the target edentulous area, anchored to an apical aspect of an osteotomy, so that the socket may be drilled along a target path which would provide optimal stability for an implant inserted into the socket. For example, the angulation and/or orientation of the implant should provide the implant with sufficient surrounding bone and be in alignment with and/or provide sufficient clearance from any adjacent structures. In particular, for single unit, partial edentulism cases with sufficient bone, the guide device 100 provides a user (e.g., oral surgeon, periodontist, etc.) an option for immediate surgical execution with tactile control and minimal setup. Thus, the guide device 100 may be especially valuable in educational and resource-constrained environments in which complex computer-guided workflows may be impractical.

In an exemplary embodiment, the guide sleeve 102 extends longitudinally from a first end 112 to a second end 114 and includes a channel 116 extending therethrough, from the first end 112 to the second end 114, along the central axis C. The first and second clamp arms 104, 106 are connected to the guide sleeve 102 via a connector 118 so that each of the first and second clamp arms 104, 106 extend along opposing sides of the central axis C.

The connector 118 may extend laterally from opposing sides of the guide sleeve 102 so that a first portion 120 of the connector 118 extends from a first side of the guide sleeve 102 to a first end 124 and a second portion 122 of the connector 118 extends from a second side of the guide sleeve 102 diametrically opposing the first side of the guide sleeve 102 to a second end 126. In an exemplary embodiment, the connector 118 extends from the second end 114 of the guide sleeve 102 and may extend along a plane substantially perpendicular to the central axis C. According to an exemplary embodiment, the connector 118 may define a first surface 128 which, in an operative position, faces toward a user (e.g., periodontist, oral surgeon) and a second surface 130 which, in the operative position, faces away from the user. The guide sleeve 102 extends from the first surface 128 of the connector 118 towards the user while, as will be described in further detail below, extends from the second surface 130. In an exemplary embodiment, the guide sleeve 102 may be recessed into the first surface 128.

According to an exemplary embodiment, the first clamp arm 104 extends from the second surface 130 of the connector 118. The first clamp arm 104 extends from a first end 132 attached to the first end 124 of the connector 118 to a second end 134 which extends away from the guide sleeve 102. In an exemplary embodiment, the first clamp arm 104 may extend at an angle relative to the central axis C such that the first clamp arm 104 tapers from the first end 132 toward the second end 134.

Similarly to the first clamp arm 104, the second clamp arm 106 may extend from a first end 136 attached to the second end 126 of the connector 118 to a second end 138. The second clamp arm 106 extends from the second surface 130 of the connector 118 in a direction away from the guide sleeve 102. In an exemplary embodiment, the second clamp arm 106 extends at an angle with respect to the central axis, tapering from the first end 136 toward the second end 138.

A length of each of the first and second clamp arms 104, 106 may be selected to substantially correspond to a desire apical depth. In the operative position, the first clamp arm 104 extends along the buccal surface of the alveolar ridge and the second clamp arm 106 extends along the lingual surface of the alveolar ridge such that the guide sleeve 102 is positioned over the alveolar ridge, in the edentulous area. According to an exemplary embodiment, each of the first and second clamp arms 104, 106 include first and second protrusions 140, 142 extending therefrom, respectively, toward the central axis to grip the surface along which the first and second clamp arms 104, 106 are positioned. The first and second protrusions 140, 142 may extend from portions of the first and second clamp arms 104, 106 proximate the second ends 134, 138, respectively. The first and second protrusions 140, 142 may grip the buccal and lingual surfaces, respectively, to stabilize the guide device 100 relative to the target edentulous area and in particular, to anchor the apical aspect of the osteotomy.

In an exemplary embodiment, each of the first and second protrusions 140, 142 may be configured as, for example, a pin, a tooth, or other projecting surface feature. It will be understood by those of skill in the art, however, that the first and second protrusions 140, 142 may have any of a variety of configurations so long as the first and second protrusions 140, 142 are configured to grip/engage a surface along which the first and second clamp arms 104, 106 are positioned. According to an exemplary embodiment, the first and second protrusions 140, 142 may be configured to engage a natural contour of gingiva along the alveolar.

It will be understood by those of skill in the art that the first and second clamp arms 104, 106 should have sufficient elasticity so that the guide device 100 may be placed over the alveolar ridge. In particular, the second ends 134, 138 of the first and second clamp arms 104, 106 may flex away (e.g., deform) away from one another to receive the alveolar ridge therebetween. The first and second clamp arms 104, 106, however, should also be sufficiently rigid so that, once the guide device 100 is placed over the alveolar ridge in the operative position, the alveolar ridge is gripped therebetween. In an exemplary embodiment, portions of the guide device 100 may be formed of material such as, for example, Polyether Ether Ketone (PEEK). In some embodiments, a rigidity of the first and second clamp arms 104, 106 may be adjusted by varying, for example, a thickness or other aspects of a size and/or shape thereof. In another exemplary embodiment, portions of the guide device 100, including the first and second clamp arms 104, 106 may be formed of a different material such as, for example, stainless steel.

In an exemplary embodiment, the first and second clamp arms 104, 106 may mirror one another about a plane A which extends through the central axis. In an exemplary embodiment, the plane A may also extend substantially perpendicular to one of the first and second surfaces 128, 130 of the connector 118. In one aspect, the first and second clamp arms 104, 106 may be equidistant from the central axis C, having the same angulation relative thereto. A distance between the first and second clamp arms 104, 106 may be selected to substantially correspond to a width of the alveolar ridge – e.g., a distance between the buccal and lingual surfaces thereof. The first and second clamp arms 104, 106 may be configured so that when the guide sleeve 102 is clamped over the alveolar ridge via the first and second clamp arms 104, 106, the guide sleeve is anchored with respect to the apical aspect of the osteotomy – e.g., the socket to be drilled to accommodate the implant post – so that a depth of the osteotomy is substantially centered between the buccal and lingual surfaces.

As described above, the guide device 100 may further comprise the first and second flanges 108, 110 for providing a mesiodistal alignment of the socket to be drilled using the guide sleeve 102 (and the implant to be inserted therein) with adjacent structures such as, for example, teeth on opposing sides of the target edentulous area. Each of the first and second flanges 108, 110 may extend from first and second edges 144, 146 of the connector 118 which extends between the first and second ends 126, 138 of the connector 118 so that, in an operative position, the first and second flanges 108, 110 are received within the target edentulous area between and in contact with, for example, two adjacent teeth.

The first flange 108 may extend from a first end 148 connected to a first edge 144 of the connector 118 to a second end 150 extending in a direction away from the guide sleeve 102 and away from the user of the device, in the operative position. Similarly, the second flange 110 may extend from a first end 152 connected to a second edge 146 of the connector 118 to a second end 154 extending in a direction away from the guide sleeve 102 and the user in the operative position. The first and second flanges 108, 110 may diametrically oppose one another and, in an exemplary embodiment, may be mirror images of one another about a plane B which extends through the central axis C substantially perpendicular to the plane A. A distance between the first and second flanges 108, 110 may substantially correspond to a size of the target edentulous area and, in a particular embodiment, may correspond to a distance between adjacent structures of the target edentulous area.

Each of the first and second flanges 108, 110 may be sized, shaped and configured to engage a structure adjacent the target edentulous area. In an exemplary embodiment, the first and second flanges 108, 110 may be sized, shaped, and configured to engage the natural undercut of an adjacent tooth so that the guide device 100 may be releasably fixed between a pair of teeth on opposing sides of the target edentulous area. In one example, the second ends 150, 154 of the first and second flanges 108, 110 may be flared outward, away from the central axis C, to engage the undercuts of the adjacent teeth.

The first and second flanges 108, 110 may be configured to flex (e.g., deform) inward, toward one another, as the first and second flanges 108, 110 are inserted into the target edentulous area, between adjacent teeth. Once the second ends 150, 154 are received within the undercuts of the teeth, however, the first and second flanges 108, 110 revert toward their initial biased configuration so that the first and second flanges 108, 110 are releasably fixed within the target edentulous area between the teeth via the engagement of the first and second flanges 108, 110 with the adjacent teeth. Thus, the first and second flanges 108, 110 position the guide sleeve 102 in mesiodistal alignment with the adjacent teeth. Since the first and second flanges 108, 110 are configured to be received within the target edentulous area, in an exemplary embodiment, a length of the first and second flanges 108, 110 is shorter than the length of the first and second clamp arms 104, 106.

According to an exemplary embodiment, as shown in FIG. 6-7, the guide device 100 may further comprise a metal insert 156 sized, shaped and configured to be inserted into the channel 116 of the guide sleeve 102. The metal insert 156 includes a channel 158 extending therethrough along an axis which, when the metal insert 156 is received within the channel 116 of the guide sleeve 102, extends coaxially with the central axis C. The channel 158 of the metal insert 156 is sized, shaped and configured to guide an implant drill 160 therethrough for drilling a socket into, for example, the alveolar, along the central axis C. In an exemplary embodiment, a portion of the metal insert 156 may be configured to engage a portion of the implant drill 160 so that the implant drill 160 may only drill the socket to a predetermined depth, as shown in FIG. 7. For example, the channel 158 may include a shoulder sized, shaped and configured to engage a flange along a portion of the implant drill 160 so that the implant drill 160 is prevented from moving longitudinally therepast – e.g., a distal tip 162 of the implant drill 160 may only extend beyond the guide sleeve 102 and the second surface 130 of the connector 118 by a desired distance corresponding to the desired depth of the socket.

According to an exemplary embodiment, the guide device 100 may be manufactured via 3D printing. The guide device 100 may be 3D printed based on measurements of, for example, the target edentulous area and the alveolar within which an implant is to be placed. In an exemplary embodiment, length of the first and second clamp arms 104, 106 may be selected to substantially correspond to a desired depth of osteotomy while a distance between the first and second clamp arms 104, 106 may be selected to substantially correspond to a width of the alveolar ridge. As described above, a size, shape and configuration of the first and second flanges 108, 110 may be selected to substantially correspond to a length of the target edentulous area (e.g., a distance between adjacent teeth on opposing sides of the target edentulous area) so that the first and second flanges 108, 110 fit within the target edentulous area and engage the adjacent structures.

It will be understood by those of skill in the art that the guide device 100 may be available in a plurality of sizes and configurations so that a user may select an appropriate guide device 100 based on a target edentulous area to be treated. It will also be understood by those of skill in the art that although the guide device 100 is described and shown as being formed of a material that may be 3D printed, in some embodiments, at least a portion of the guide device may be formed of a metal such as, for example, stainless steel. In an exemplary embodiment, the first and second clamp arms 104, 106 may be formed of stainless steel to achieve a desired rigidity thereof. In an even further embodiment, the entirety of the guide device 100 may be formed of a material such as, for example, stainless steel.

According to an exemplary method 200, as shown in FIG. 10, which utilizes the guide device 100, as described above, the user may determine a size of an implant (e.g., a length of an implant post) to be implanted into the alveolar of a target edentulous area 10, in a step 210. As will be understood by those of skill in the art, the size of the implant may be determined based on, for example, previously acquired diagnostic imaging. An appropriately sized and shaped guide device 100 may then be selected, in a step 220, based on the target edentulous area 10 and/or the determined size of the implant. For example, the guide device 100 may be selected to have first and second clamp arms 104, 106 having a length corresponding to a desired depth of insertion of an implant, which may correspond to a length of the implant post to be implanted, and distance between the first and second clamp arms 104, 106 may be selected to correspond to a width of the alveolar ridge over which the target edentulous area 10 extends. A length of the first and second flanges 108, 110 and a distance therebetween may be selected to correspond to a size of the target edentulous area 10 – e.g., a distance between adjacent teeth on opposing sides of the target edentulous area 10.

In a step 230, upon selection of an appropriately sized and configured guide device 100, the guide device 100 may be placed over the alveolar ridge, as shown in FIG. 8, so that the first and second clamp arms 104, 106 extend over buccal and lingual surfaces 12, 14, respectively. The first and second protrusions 140, 142 of the first and second clamp arms 104, 106 may grip the surfaces, anchoring the guide device 100 in the target edentulous area 10 relative to the apical aspect of the osteotomy which, as will be understood by those of skill in the art, may correspond to the length of the selected implant. Thus, according to an exemplary embodiment, a central axis of the guide sleeve 102 is centered between the buccal and lingual surfaces of the apical aspect.

In an exemplary embodiment, as the guide device 100 is positioned in the target edentulous area 10 as described above, the first and second flanges 108, 110 are fit between adjacent anatomical structures such as, for example, a first tooth 16 and a second tooth 18. The first flange 108 may engage the first tooth 16 while the second flange 110 may engage the second tooth 18 so that the guide sleeve 102 and the central axis C are also in mesiodistal alignment with the adjacent teeth 16, 18. Thus, the central axis C extends through alveolar bone at a desired angulation/orientation relative thereto and in mesiodistal alignment with adjacent structure.

In a step 240, the user may then drill along the central axis C of the guide sleeve 102 through, for example, the metal insert 156, to drill a socket into the alveolar. The user may select the implant drill 160 corresponding in length to the desired length of the implant to be inserted into the target edentulous area 10. As described above, a portion of the implant drill 160 may engage the metal insert 156 to ensure that the socket will only be drilled to the desired depth. Once the socket has been drilled, an implant may be inserted therein according to conventional practice, as will be understood by those of skill in the art.

Although the exemplary embodiments show and describe the guide device 100 as being placed in a target edentulous area having adjacent structures (e.g., teeth) on both sides mesially and distally thereof, it will be understood by those of skill in the art that the guide device 100 may similarly be utilized for replacement of a distal-most tooth where the target edentulous area 10 is adjacent just one tooth 16 positioned mesially thereof. As shown in FIG. 9, the first and second clamp arms 104, 106 may be positioned over buccal and lingual surfaces as described above, and just one of the flanges (e.g., the first flange 108) may be engaged to the tooth 16. The first and second clamp arms 104, 106 and the first flange 108 provide sufficient stability of the guide device 100 in the target edentulous area 10 such that the central axis C is in alignment with an optimal path of insertion of an implant into the target edentulous area 10.

The disclosure described and claimed herein is not to be limited in scope by the specific embodiments herein disclosed since these embodiments are intended as illustrations of several aspects of this disclosure. Any equivalent embodiments are intended to be within the scope of this disclosure. Indeed, various modifications of the disclosure in addition to those shown and described herein will become apparent to those skilled in the art from the foregoing description. Such modifications are also intended to fall within the scope of the appended claims.

What is claimed is:

1. A device for guided pilot osteotomy in preparation for a dental implant, comprising:
a guide sleeve extending longitudinally from a first end to a second and including a channel extending therethrough along a central axis; and
a first clamp arm and a second clamp arm extending from opposing sides of the guide sleeve, the first and second clamp arms configured to be positioned along buccal and lingual surfaces of an alveolar ridge to position the guide sleeve in the target edentulous area so that the central axis of the channel extends along a desired path of insertion of an implant.

2. The device of claim 1, further comprising:
a first flange extending from the guide sleeve, between the first clamp arm and the second clamp arm so that when the first and second clamp arms extend over buccal and lingual surfaces, respectively, in an operative position, the first flange is configured to engage a first adjacent structure positioned mesially of the target edentulous area.

3. The device of claim 2, further comprising:
a second flange extending from the guide sleeve so that the second flange diametrically opposes the first flange, the second flange configured to engage a second adjacent structure positioned distally of the target edentulous area so that the guide sleeve is in mesiodistal alignment with the first and second adjacent structures.

4. The device of claim 3, wherein the first and second flanges are sized and shaped to engage an undercut of adjacent dentitions’ interproximal region mesial and distal positions.

5. The device of claim 2, wherein each of the first and second clamp arms include a protrusion extending therefrom toward the central axis to engage the buccal and lingual surfaces, in the operative position, the protrusions stabilize the guide sleeve in the target edentulous area and anchors the guide sleeve relative to an apical aspect of an osteotomy so that the central axis is centered with respect to the apical aspect.

6. The device of claim 1, wherein each of the first and second clamp arms are connected to the guide sleeve via a connector extending laterally from the guide sleeve from opposing sides thereof, each of the first and second clamp arms extend from a first end connected to connector to a second end.

7. The device of claim 6, wherein each of the first and second clamp arms taper from the first end toward the second end.

8. The device of claim 1, wherein the first and second clamp arms are equidistant from the central axis of the channel of the guide sleeve.

9. The device of claim 1, wherein a distance between the first and second clamp arms corresponds to a width of the alveolar ridge along the target edentulous area.

10. The device of claim 3, wherein a distance between the first and second flanges corresponds to a size of the target edentulous area.

11. The device of claim 1, further comprising:
a metal insert sized shaped and configured to be received within the channel of the guide sleeve so that a channel of the metal insert extends coaxially therewith.

12. The device of claim 11, wherein a portion of the metal insert is sized, shaped and configured to engage a portion of an implant drill to define a maximum extent of insertion of the implant drill therethrough.

13. A device for guided pilot osteotomy in preparation for a dental implant, comprising:
a guide sleeve extending longitudinally from a first end to a second and including a channel extending therethrough along a central axis; and
a first clamp arm and a second clamp arm extending from opposing sides of the guide sleeve, the first and second clamp arms configured to be positioned along buccal and lingual surfaces of an alveolar ridge to position the guide sleeve in the target edentulous area so that the central axis of the channel extends along a desired path of insertion of an implant that is anchored with respect to an apical aspect of an osteotomy; and
a first flange and a second flange extending from opposing sides of the guide sleeve, the first and second flanges being sized, shaped and configured to engage adjacent structures on either side of the target edentulous area to provide a mesiodistal alignment of the central axis of the guide sleeve.

14. The device of claim 13, further comprising:
a metal insert sized shaped and configured to be received within the channel of the guide sleeve so that a channel of the metal insert extends coaxially therewith.

15. The device of claim 14, wherein the metal insert is sized, shaped and configured to engage a portion of an implant drill.

16. The device of claim 13, wherein each of the first and second clamp arms includes a protrusion extending therefrom, toward the central axis of the channel, to the buccal and lingual surfaces over which the first and second arms extend.

17. The device of claim 13, wherein each of the first and second clamp arms taper from a first end connected to the guide sleeve toward a second free end.

18. The device of claim 13, wherein each of the first and second flanges extend from a first end connected to the guide sleeve to a second free end that is sized, shaped and configured to engage an undercut of a tooth.

19. A method for accurate pilot drilling in preparation for a dental implant, comprising:
positioning a guide device over an alveolar ridge of a target edentulous area such that a first clamp arm of the guide device extends over a buccal surface of the alveolar ridge and a second clamp arm of the guide device extends over a lingual surface of the alveolar ridge so that a guide sleeve is anchored with respect to an apical aspect of an osteotomy and a central axis of a channel of the guide sleeve extends along a target path of insertion of an implant.

20. The method of claim 19, wherein positioning the guide device further includes engaging a flange of the guide device with an adjacent structure of the target edentulous area so that the central axis of the channel of the guide sleeve is in mesiodistal alignment with the adjacent structure.
